(19) United States
(12) Patent Application Publication
(10) Pub. No.: US 2008/0023930 A1
(43) Pub. Date: Jan. 31, 2008

(54) Vehicle anti-roll system, dynamic handling system hose, and hose coupling

(75) Inventors: Karen M. Anthon, Ocala, FL (US); Terence E. Skiba, Ocala, FL (US); Robert Williamson, Bloomfield Hills, MI (US)

Correspondence Address: DAYCO PRODUCTS, LLC, 1 PRESTIGE PLACE, MIAMISBURG, OH, 45342, US

(73) Assignee: DAYCO PRODUCTS, LLC

(21) Appl. No.: 11/494,702

(22) Filed: Jul. 27, 2006

(51) Int. Cl. B60G 21/055; B62D 49/08

(52) U.S. Cl. 280/124.107; 280/755; 280/124.106; 280/124.157

(57) ABSTRACT

A dynamic handling system hose for use in a vehicle anti-rollover system, wherein the dynamic handling system hose comprises: a tubular body comprising a polymeric material exhibiting (1) zero or near zero expansion coefficient, (2) sufficient flexibility to withstand rough terrain, (3) high tensile strength, (4) low elongation, (5) high tolerance to extreme temperature ranges, (6) high resistance to hydrocarbon fluids, and (7) relatively low weight compared to conventionally used hose materials in anti-rollover systems; a reinforcement around the tubular body; and a protective cover surrounding the tubular body and the reinforcement, and a coupler for coupling the dynamic handling system hose to an appropriate actuator in a vehicle anti-rollover system are described.

### BACKGROUND OF THE INVENTION

The invention relates generally to anti-roll systems and particularly to hoses for use as conduits in vehicle stabilizing systems to prevent rollover of the vehicle when the vehicle is in motion; hose coupling for coupling the hose to the anti-rollover system, and to dynamic handling, anti-roll systems employing such hoses and coupling.

The high center of gravity typically associated with most off-road vehicles such as the currently popular sport utility vehicles (SUV's) and even on-road vehicles, e.g., vans, trucks, etc. have led to an alarmingly high number of accidents involving roll-over of the vehicle.

Typically, a vehicle consists of a vehicle body which is generally rectangular in shape, a frame to which the vehicle body is secured, four wheels fitted with rubber tires in close proximity with the four corners of the vehicle body, front and rear axles for mounting two of the wheels at the front of the vehicle and the two remaining wheels at the rear of the vehicle, and a suspension system for connecting the vehicle body to the axles.

When a vehicle veers from a straight path, forces exerted upon the vehicle causes the stability of the vehicle to become compromised. For example, a vehicle having a high center of gravity or one having a heavy or unbalanced load, tends to roll and pitch when the vehicle is steered into a turn. If the turn is severe or unexpected, the vehicle often cannot adequately compensate for the forces resulting from the roll and pitch of the vehicle caused by the turn and, as a consequence, the vehicle may be involved in an uncontrollable roll over accident.

Anti-roll systems, which are designed to counteract vehicle roll, are known in the art. Typically, such systems provide lifting and lowering forces of the vehicle body in relation to the suspension during the turn of the vehicle. For example, U.S. Pat No. 6,588,799 to Sanchez; U.S. Pat. No. 5,219,181 to Lund; U.S. Pat. No. 4,589,678 to Lund; U.S. Pat. No. 4,345,661 to Nishikawa; U.S. Pat. No. 4,076,275 to Hiruma; U.S. Pat. No. 4,030,777 to Rabenseifner; U.S. Pat. No. 3,893,680 to Marcillat et al.; U.S. Pat. No. 3,885,809 to Pitcher; U.S. Pat. No. 3,871,681 to Piniot; U.S. Pat. No. 3,820,812; to Stubbs; U.S. Pat. No. 3,752,497 to Enke; U.S. Pat. No. 3,038,739 to Vogel; and U.S. Pat. No. 3,016,101 to Fiala teach anti-roll systems which utilize hydraulic and/or mechanical systems and components for generating lifting and lowering forces. Typically, anti-roll systems include an element corresponding to a cylinder and piston assembly positioned at a vehicle wheel, wherein the systems reacts to hydraulic forces to move the piston within the cylinder between the wheel and the vehicle body to provide appropriate lifting or lowering to prevent roll over of the vehicle. Ideally, in order to prevent rollover of vehicles, particularly those vehicles having a high center of gravity such as to have an instantaneous response from the hydraulic system to tilting conditions caused by jouncing and yawing of the vehicle, while maintaining the structural integrity of the system. Furthermore, it is desirable that driver and passenger comfort not be sacrificed as a result. Previously, vehicle anti-rollover systems relied on metal pipe as the hydraulic conduit or, in some cases, polymeric materials. However, metal pipe is cumbersome, rigid and takes up more critical space than is desired in the vehicle. Customary polymeric materials are flexible, but provide too much expansion during pressure pulsations.

Accordingly, there is a need in the automotive industry for a flexible hydraulic conduit of a synthetic polymeric material, which is easily adaptable for use in relatively small quarters, has a zero or near zero expansion rate under extreme hydraulic pressure, and which is relatively cost effective to produce and use. There is also a need in the industry for a vehicle anti-rollover system employing such synthetic polymeric material as a flexible hydraulic conduit to provide improved anti-roll characteristics in a vehicle which overcomes the problems associated with previous anti rollover systems.

### SUMMARY OF THE INVENTION

In order to prevent rollover of vehicles, particularly those vehicles having a high center of gravity such as SUV's, such vehicles are equipped with an anti-rollover system. It is desirable that the anti-rollover system has an instantaneous response from the hydraulic system to tilting conditions caused by jouncing and yawing of the vehicle without sacrificing driver and passenger comfort. Furthermore, it is desirable that the structural integrity of the hydraulic system be maintained. In accordance with the invention, there is provided a flexible hose member which is extremely durable and which exhibits from zero to near zero expansion under conditions of high-pressure pulsations. The hose is especially useful in applications where such characteristics are required, e.g., in vehicle anti-rollover systems wherein the anti-rollover system reacts instantaneously to adverse tilting conditions of the vehicle, while preserving the structural integrity of the system.

In accordance with one embodiment of the invention, there is provided an improved synthetic polymer material useful in the manufacture of a tubular structure having zero to low expansion, is extremely flexible and is very durable during pressure pulsations. The synthetic material is useful in the formation of a tubular structure for use in an anti-rollover system. Such tubular structure would have a low profile sufficient to be oriented on the vehicle in a manner so as to take up as little space as possible, be flexible enough to withstand the jounce and yaw of the vehicle dynamics during movement, and be relatively cost effective. Furthermore, the synthetic polymeric hose of the present invention is significantly lighter in weight than the metal conduits currently used in anti-rollover systems.

In accordance with another embodiment of the invention, there is provided an improved anti-rollover system employing the improved synthetic polymer material, which imparts enhanced stability to a moving vehicle under adverse conditions.

In accordance with still another embodiment of the invention, there is provided a coupling member for locking the various parts of the anti-roll system together.

The above embodiments and advantages of the present invention will become apparent from the following detailed description and the accompanying drawings, which illustrate the preferred embodiments of the invention.

### BRIEF DESCRIPTION OF THE DRAWINGS

FIG. 1 is a perspective cut away view of a flexible dynamic handling system hose in accordance with the invention;

FIG. 2 is a sectional plan view of a coupler used in accordance with the invention to couple the flexible dynamic system hose to a hydraulic actuator;

FIG. 3 is a sectional plan view of the flexible dynamic handling system hose of the invention joined to a hydraulic actuator via a coupler; and

FIG. 4 is a diagram of a vehicle anti-roll system in accordance with the invention.

### DETAILED DESCRIPTION OF THE INVENTION

The automotive industry is constantly searching for new materials and systems which would not only lead to improved performance of the various components of an automotive vehicle, but which would lead to a lighter weight vehicle without sacrificing safety and performance.

It has been found that a particular group of polymeric materials, when constructed and employed as dynamic handling system hoses in accordance with the present invention, offers superior characteristics over those hoses presently used in anti-rollover systems. For example, the polymeric dynamic handling system hoses demonstrate improved characteristics of (1) zero or near zero expansion coefficient, (2) sufficient flexibility to withstand rough terrain, (3) high tensile strength and low elongation, (4) high tolerance to extreme temperature ranges, (5) high resistance to hydrocarbon fluids, and (6) are significantly lower in weight than those commonly used in anti-rollover systems. Metal tubes are rigid making them extremely susceptible to road vibrations as well as adding undesirable weight problems to the system. Furthermore, metal tubes are difficult and time consuming to install. Polymeric materials have been employed as anti-rollover hydraulic tubes, but such tubes lack the desired characteristics. For example, such polymeric hoses lack sufficient flexibility because of the amount of reinforcement necessary to compensate for their high expansion coefficient expansion of the tube. The addition of large amounts of reinforcement also adds to the weight of the polymeric hoses. Therefore, the prior art hoses are only marginally effective.

Accordingly, it has now been found that the anti-rollover system of a motor vehicle can be substantially improved while reducing the overall weight of the motor vehicle by employing a hose manufactured in accordance with the present invention as the fluid conduit associated with the anti-rollover system employed in the motor vehicle.

The polymeric material from which the flexible dynamic handling system hose of the present invention is formed is critical. Extensive investigations were carried out involving a number of synthetic polymeric materials, which exhibit one or more of the desired characteristics. Polyesters, such as polyethylene terephthalate and polyamides, such as nylons exhibited too much elongation and did not have high enough strength without requiring excessive amounts of reinforcement. Also such hoses exhibit an undesirable amount of volumetric expansion, which inhibits vehicle response time for the actuators. Kevlar, an aromatic polyamide available from Dupont, exhibits extremely high tensile strength, high resistance to elongation, and good energy absorption; however, it is very difficult to obtain sufficient adhesion between the Kevlar and the cover layer.

In addition to the criticality of the material from which the hose is constructed, it is also critical to form the hose having certain preferred dimensions. For example, the hose of the invention is constructed to have an outer diameter of about 0.100-2.00 inches, more specifically about 0.500-1.000 inches, and an inner diameter of about 0.010-1.00 inches, more specifically about 0.100 to 0.500 inches.

The particular reinforcement material, the amount of reinforcement material, and the orientation of the reinforcement strands positioned around the hose are all critical to the performance of the hose in a vehicle anti-rollover system. Commonly used reinforcement materials such as polyester (PO), polyamide, e.g., nylon, and combination thereof are generally undesirable because of the need to use high reinforcement loads (multiple strand of reinforcement). Other materials such as aramids are generally unsatisfactory because of their lack of adhesion properties. In a highly preferred aspect of the invention, Polyvinyl alcohol (PVA) is employed as the reinforcement of choice since Polyvinyl alcohol exhibits the characteristics desired and can be employed in single or multiple layers of reinforcement and with single or multiple ends of reinforcement.

In a highly preferred aspect of the invention, the dynamic handling system hose inner tube and outer cover of the present invention consists of Natural Rubber (NR), Chlorinated Polyethylene (CPE), Chlorosulfonated Polyethylene (CSM), Nitrile-Butadiene Rubber (NBR), Hydrogenated Nitrile-Butadiene Rubber (HNBR), Ethylene-Propylene-Diene Rubber (EPDM), Carboxalated Hydrogenated Nitrile-Butadiene Rubber (XHNBR), EVA (Ethylene Vinyl Acetate), HSBR (Hydrogenated Styrene Butadiene Rubber), SBR (Styrene Butadiene Rubber), HSN (Highly Saturated Nitrile) and/or ACSM (Alkalated Chlorosulfonated Polyethylene) and blends thereof. Preferably, each of the inner tube and outer cover is formed from a mixture of about 1-99 PHR chlorinated polyethylene and about 1-99 PHR chlorosulfonated polyethylene.

The hose of the invention is constructed to have an outer diameter of about 0.100-2.00 inches, more specifically about 0.500-1.000 inches, and an inner diameter of about 0.010-1.00 inches, more specifically about 0.100 to 0.500 inches.

The hose will be reinforced with polyvinyl alcohol material wherein the braid angle of the polyvinyl alcohol material around the outer circumference of the tube is between about 30-60° and preferably, between about 50-54° with respect to the longitudinal axis of said hose. A hose of this construction provides the desirable characteristics for use as a vehicle anti-rollover hose. A dynamic handling system hose made from polyvinyl alcohol or Kevlar and having a braid angle of 52° has been found to exhibit excellent burst strength under pressure pulsations while preventing the dynamic handling hose from expanding beyond 4 cc/ft when tested at 1500 psi. While both polyvinyl alcohol and Kevlar provide the desired characteristics of high burst strength and low elongation for use in a dynamic handling, vehicle anti-rollover system, Kevlar presents problems of low adhesion to other materials which may be used as the cover layer.

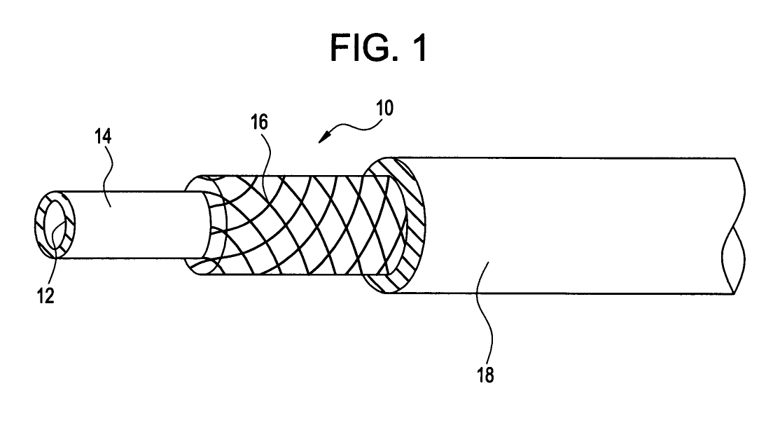

Turning now to the drawings, FIG. 1 illustrates a synthetic polymeric dynamic handling hose 10, which comprises an inner surface 12 and an outer surface 14. Wrapped around the outer surface 14 of the flexible dynamic handling system hose 10 is a reinforcing material 16. A cover layer 18 is applied to surround the synthetic polymer hose 10 and the reinforcing material 16.

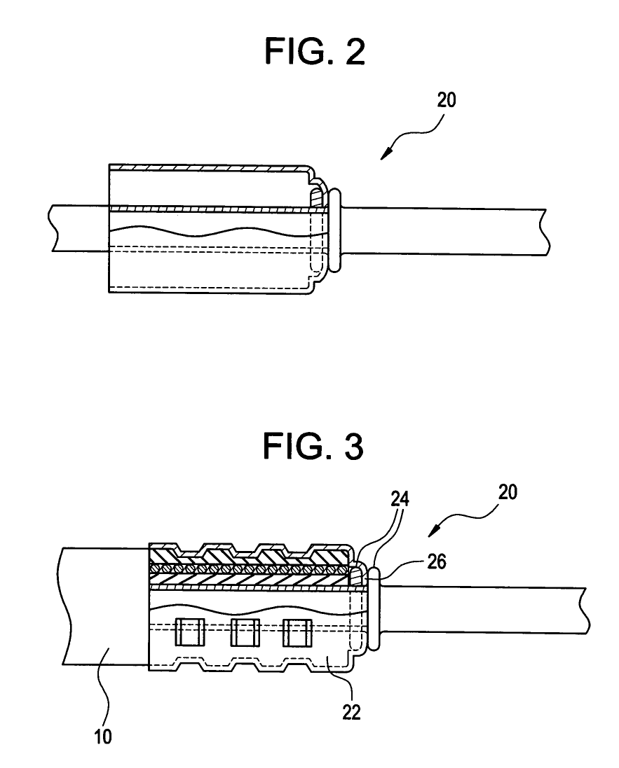

FIG. 2 illustrates a coupling device 20, which is used to couple the dynamic handling hose 10 to the appropriate hydraulic actuator of an anti-rollover system. The coupling device 20 includes a shell 22, preferably made from aluminum. By using aluminum and end forming (mechanically locking) the coupling device 20 it is not necessary to braze the pieces together. This allows for fast assembly of the coupling device to a hose 10 (FIG. 3) at a substantially reduced cost. Typically, the coupling device 20 is manufactured by sandwiching the shell 22 between two steel beads 24. The steel is upset by forming punches. Beneath the shell 22 and in each of the two beads 24, there is a groove 26, which preferably has a square shape to accommodate the shell 22 and allow the hose 10 to flow into the groove 22. The square groove provide good sealing when the shell and hose are swaged to the stem. Also a square groove allows the OD of the stem to be maintained as small as possible, thus having the lowest push-on possible. Upon securing the coupling device 20 to the hose 10 preferably by crimping, the hose 10 seals into the groove 26.

FIG. 3 illustrates the hose 10 of the present invention secured to the coupling device 20 by end forming the coupling device 20. The dynamic handling system hose is “pressed” on the end of the dynamic handling device 20 where it collapses on itself to form the first (outer) bead. Then a shell 22 is picked up and is slid on the dynamic handling hose 10 while the dynamic handling hose 10 is again pressed on the end of the coupling device 20 to collapse on itself and lock the shell 22 into place. A swage (not shown) then deforms the shell 22 providing a plurality of depressions 27 which secure the hose 10 to the shell 22 and, also secures the dynamic handling hose 10 into the groove 26 on the stem. By pressing the dynamic handling hose 10 into the groove on the stem, the dynamic handling hose 10 fills the groove to provide sealing of the dynamic handling hose 10.

While the coupling device 20 is preferably made of aluminum, it is within the scope of the invention to form the coupling device 20 from steel. The use of steel as the material for the coupling device 20 would produce the same results, but it would be less cost effective than the mechanical locked coupling.

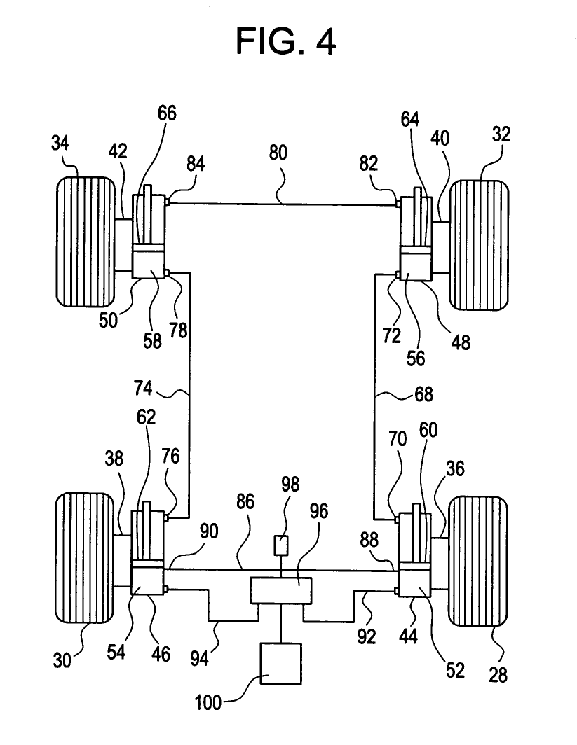

FIG. 4 is a diagram illustrating a reinforced polymeric hose of the present invention in a vehicle anti-rollover system. Anti-rollover systems in automotive vehicles are well known in the art and there is no need to specifically show or describe such systems in detail here. With respect to FIG. 4, numerals 28, 30, 32 and 34 represent left front, right front, left rear and right rear wheels, respectively, on corresponding axles 36, 38, 40 and 42 for he purpose of showing the orientation of the anti-rollover system. Adjacent the wheels 28, 30, 32, and 34, respectively, are corresponding hydraulically actuated cylinder assemblies, 44, 46, 48 and 50, which comprise cylinders 52, 54, 56 and 58 and the corresponding pistons 60, 62, 64 and 66, respectively. Hydraulic line 68 connects the left front hydraulically actuated cylinder assembly 44 to the left rear hydraulically actuated cylinder assembly 48 via upper port 70 on the left front hydraulically actuated cylinder assembly 44 and lower port 72 on the left rear hydraulically actuated cylinder assembly 48; and hydraulic line 74 connects the right front hydraulic actuated cylinder assembly 46 to the right rear hydraulically actuated cylinder assembly 50 via upper port 76 on the right front hydraulically actuated assembly 46 and the lower port 78 on the right rear hydraulically actuated cylinder assembly 50. Hydraulic line 80 connects the left rear hydraulically actuated cylinder assembly 48 to the right rear hydraulically actuated cylinder assembly 50 via upper port 82 on the left rear hydraulically actuated cylinder assembly 48 and the upper port 84 on the right rear hydraulically actuated cylinder assembly 50; and hydraulic line 86 connects the left front hydraulically actuated cylinder 44 to the right front hydraulically actuated cylinder assembly 46 via lower port 88 on the left front hydraulically actuated cylinder assembly 44 and the lower port 90 on the right front hydraulically activated cylinder assembly 46. Hydraulic lines 92 and 94 connect the left front hydraulically activated cylinder assembly 44 and the right front hydraulically actuated cylinder assembly 46, respectively. A valve 96 through which hydraulic liquid is provided, responds to a signal caused by an adverse movement of the vehicle further causing a pump 98 to be activated forcing hydraulic fluid from a reservoir 100 to one side of the vehicle or the other depending on the nature of the adverse movement of the vehicle.

As explained above, the material from which the polymeric dynamic handling system hose of the invention is critical. Typically, the hose is formed from a polymeric material which has (1) zero or near zero expansion coefficient, (2) sufficient flexibility to withstand harsh vibrations, (3) high tensile strength and low elongation, (4) high tolerance to extreme temperature ranges, (5) high resistance to hydrocarbon fluids, and (6) lower weight than those commonly used in current anti-rollover systems. Depending of the dimensions of the hose used in an automotive anti-rollover system and the stability of the hose under certain temperature requirements, polymeric materials useful in carrying out the invention include Natural Rubber (NR), Chlorinated Polyethylene (CPE), Chlorosulfonated Polyethylene (CSM), Nitrile-Butadiene Rubber (NBR), Hydrogenated Nitrile-Butadiene Rubber (HNBR), Ethylene-Propylene-Diene Rubber (EPDM), XHNBR (Carboxalated Hydrogenated Nitrile-Butadiene Rubber), EVA (Ethylene Vinyl Acetate), HSBR (Hydrogenated Styrene Butadiene Rubber), SBR (Styrene Butadiene Rubber), HSN (Highly Saturated Nitrile), ACSM (Alkalated Chlorosulfonated Polyethylene) and blends thereof. In a particular aspect of the invention, the preferred materials used to form the dynamic handling system hose of the invention is a mixture of chlorinated polyethylene and chlorosulfonated polyethylene.

The coupling member used to couple the dynamic handling system hose to the anti-rollover system comprises a shell sandwiched between two beads of steel. Underneath the shell there is formed a groove which is preferably has a square shape. This design allows the hose to flow into the groove. Upon crimping, the hose seal into the groove pattern. Typically, the groove pattern has the dimensions of about 0.010 to 0.100 inch wide and about 0.008 to 0.015 inch deep. The coupling member can be made from any lightweight material, which is inert to the environment of the fluid used in the anti-rollover system, and provides sufficient longevity. Preferably, the coupling member is formed of aluminum and has a thickness of about 0.04 to 0.06 inches. The use of an aluminum shell member having a thickness of about 0.05 is preferred because it is inert and can be easily endorsed (mechanically locked) so that it is unnecessary to braze or weld the coupling to the anti-rollover system. Other materials such as steel tubing having outer dimensions of about 0.325 to 0.450 inch and a wall thickness of about 0.028 to 0.065 inch may be employed. Steel tubing having an OD of about 0.375 and a wall thickness of about 0.035 inch has been found to provide satisfactory results. However, such materials typically need to be welded or brazed in order to provide results similar to aluminum. The use of such materials would be more expensive and generally provide increased weight to the system in which they are used.

While certain preferred embodiments have been described herein, it will understood that a latitude of modification and substitution is intended in the foregoing disclosure, and that these modifications and substitutions are considered to be within the spirit and scope of the invention claimed in the appended claims.

What is claimed is:

1. A dynamic handling system hose for use in a vehicle anti-rollover system, said dynamic handling system hose comprising:
1. a tubular body comprising a polymeric material exhibiting
a. zero or near zero expansion coefficient,
b. sufficient flexibility to withstand rough terrain,
c. high tensile strength,
d. low elongation,
e. high tolerance to extreme temperature ranges,
f. high resistance to hydrocarbon fluids, and
g. relatively low weight compared to conventionally used conduit materials in anti-rollover systems;
2. a reinforcement around said tubular body; and
3. a protective cover surrounding said tubular body and said reinforcement.

2. The dynamic handling system hose of claim 1 wherein each of said dynamic handling system hose inner tubular body and said outer cover are formed of natural rubber (NR), chlorinated polyethylene (CPE), chlorosulfonated polyethylene (CSM), nitrile-butadiene rubber (NBR), hydrogenated nitrile-butadiene rubber (HNBR), ethylene-propylene-diene rubber (EPDM), XHNBR (carboxalated hydrogenated nitrile-butadiene rubber), EVA (ethylene vinyl acetate), HSBR (hydrogenated styrene butadiene rubber), SBR (styrene butadiene rubber), HSN (highly saturated nitrile), ACSM (alkalated chlorosulfonated polyethylene) or blends thereof.

3. The dynamic handling system hose of claim 2 wherein each of said dynamic handling system hose inner tube and said outer cover are formed of a blend comprising about 1-99 PHR of chlorinated polyethylene (CPE) and about 1-99 PHR of chlorosulfonated polyethylene (CSM).

4. The dynamic handling system hose of claim 1 wherein said dynamic handling system hose has an outer diameter of about 0.100-2.00 inches and an inner diameter of about 0.010-1.00 inch.

5. The dynamic handling system hose of claim 4 wherein said dynamic handling system hose has an outer diameter of about 0.500-1.00 inch and an inner diameter of about 0.100-0.500 inch.

6. The dynamic handling system hose of claim 1 wherein said reinforcement is polyvinyl alcohol.

7. The dynamic handling system hose of claim 6 wherein said reinforcement is applied around said dynamic handling system hose in a single or multiple layers and with single or multiple ends.

8. The dynamic handling system hose of claim 7 wherein said reinforcement is applied around said dynamic handling system hose wherein the reinforcement is braided around said dynamic handling system hose at an angle of between about 10 to 90° with respect to the longitudinal axis of said dynamic handling system hose.

9. The dynamic handling system hose of claim 7 wherein said reinforcement is braided around said dynamic handling system hose at an angle of between about 30 to 60° with respect to the longitudinal axis of said dynamic handling system hose.

10. The dynamic handling system hose of claim 7 wherein said reinforcement is braided around said dynamic handling system hose at an angle of between about 50 to 54° with respect to the longitudinal axis of said dynamic handling system hose.

11. A coupler for use in coupling a dynamic handling system hose to an automotive anti-rollover system, said coupler comprising: a pair of steel beads having a shell disposed there between, said shell having a composition and thickness effective for overcoming undo hoop stress created by high pressurization, and a groove underneath said shell such that said groove is underneath said shell, wherein said hose flows into said groove when said coupler is secured to said dynamic handling system hose.

12. The coupler of claim 9 wherein said coupler is formed of aluminum or steel.

13. The coupler of claim 10 wherein said coupler is formed of aluminum.

14. The coupler of claim 1 wherein said coupler precludes the need to weld or braze said coupler to said anti-rollover system.

15. The coupler of claim 9 wherein said shell has a thickness of about 0.040 to 0.080 inch.

16. The coupler of claim 9 wherein said groove has a width of about 0.010 to 0.100 inch and a depth of about 0.002 to 0.015 inch.

17. In a vehicle anti-rollover system wherein a fluid under pressure is pulsed through a plurality of tubular conduits to an appropriate number of actuators which act to prevent severe tilt or rollover of the vehicle, the improvement which comprises; employing as the plurality of tubular conduits, a plurality of dynamic handling system hoses, wherein each of said dynamic handling system hoses comprises:
1. a tubular body comprising a polymeric material exhibiting:
a. zero or near zero expansion coefficient,
b. sufficient flexibility to withstand rough terrain,
c. high tensile strength,
d. low elongation,
e. high tolerance to extreme temperature ranges,
f. high resistance to hydrocarbon fluids, and
g. relatively low weight compared to conventionally used conduit materials anti-rollover systems:
2. a reinforcement around said tubular body; and
3. a protective cover surrounding said tubular body and said reinforcement; wherein each of said plurality of dynamic handling hoses is coupled to one of said appropriate number of actuators by a coupler, said coupler comprising; a pair of steel beads having a shell disposed there between, said shell having a composition and thickness effective of overcoming undo hoop stress created by high pressurization and a groove in one of said steel beads such that said groove is underneath said shell, wherein said hose flows into said groove when said coupler is secured to said dynamic handling system hose.

18. The vehicle anti-rollover system of claim 15 wherein each of said dynamic handling system hose inner tube and said outer cover are formed of natural rubber (NR), chlorinated polyethylene (CPE), chlorosulfonated polyethylene (CSM), nitrile-butadiene rubber (NBR), hydrogenated nitrile-butadiene rubber (HNBR), ethylene-propylene-diene rubber (EPDM), XHNBR (carboxalated hydrogenated nitrile-butadiene rubber), EVA (ethylene vinyl acetate), HSBR (hydrogenated styrene butadiene rubber), SBR (styrene butadiene rubber), HSN (highly saturated nitrile), ACSM (alkalated chlorosulfonated polyethylene) or blends thereof, wherein said hose has an outer diameter of about 0.100-2.00 inches and an inner diameter of about 0.010-1.00 inches

19. The vehicle anti-rollover system of claim 16 wherein each of said dynamic handling system hose inner tube and said outer cover are formed of a combination of about 1-99 PHR chlorinated polyethylene (CPE) and about 1-99 PHR chlorosulfonated polyethylene (CSM).

20. The vehicle anti-rollover system of claim 15 wherein said dynamic handling system hose has an outer diameter of about 0.500-1.000 inch and an inner diameter of about 0.100 to 0.500 inch.

21. The vehicle anti-rollover system of claim 15 wherein said reinforcement is selected from the group consisting of polyvinyl alcohol, aromatic polyamides and combinations thereof.

22. The vehicle anti-rollover system of claim 19 wherein said reinforcement is polyvinyl alcohol.

23. The vehicle anti-rollover system of claim 15 wherein said reinforcement is braided around said hose at an angle of between about 30 to 60° with respect to the longitudinal axis of said dynamic handling system hose.

24. The vehicle anti-rollover system of claim 23 wherein said reinforcement is braided around said hose at an angle of between about 50 to 54° with respect to the longitudinal axis of said dynamic handling system hose.

25. The vehicle anti-rollover system of claim 23 wherein said reinforcement is braided around said hose at an angle of about 52° with respect to the longitudinal axis of said dynamic handling system hose.
